(19) United States
(12) Patent Application Publication
(10) Pub. No.: US 2016/0086519 A1
(43) Pub. Date: Mar. 24, 2016

(54) LABEL SUBSTRATE AND METHOD FOR PRODUCING LABEL AND LABEL SUBSTRATE

(71) Applicant: CASIO COMPUTER CO., LTD., Tokyo (JP)

(72) Inventor: Tomohumi SANO, Saitama (JP)

(73) Assignee: CASIO COMPUTER CO., LTD., Shibuya-ku, Tokyo (JP)

(21) Appl. No.: 14/889,539

(22) PCT Filed: Jul. 10, 2014
(86) PCT No.: PCT/JP2014/068440

§ 371 Date: Nov. 6, 2015

(30) Foreign Application Priority Data
Sep. 20, 2013 (JP) 2013-195154

(51) Int. Cl. G09F 3/10; B05D 1/18; B05D 1/02; G09F 3/02

(52) U.S. Cl. CPC G09F 3/10; G09F 3/02; B05D 1/18; B05D 1/02

(57) ABSTRACT

A label making apparatus of the present disclosure transfers and fuses a label forming toner to a label substrate, in a desired shape. The label substrate includes a release sheet, an adhesive layer formed by applying an adhesive on the release sheet, and a coat layer formed on the adhesive layer. The coat layer is formed from at least one or a combination of a monomer or an oligomer of polyester resin and a monomer or an oligomer of an acrylic resin. The coat layer has a thickness of from 1 to 5 μm.

### TECHNICAL FIELD

The present disclosure relates to a label substrate, particularly a label substrate used in producing a label having a desired size by an electrophotographic printing process, and a method for producing a label and a label substrate.

### BACKGROUND ART

In a conventional method for producing a label, first, an image is printed on a label sheet having a surface that includes an adhesive applied thereto and that is releasably adhered to a release sheet. Then, the label sheet with the image printed thereon is cut into a desired shape with a cutter. Such method is common.

In contrast, the applicant of the present disclosure has proposed a method for producing a label by an electrophotographic printing process (Patent Literature 1). More particularly, a label forming toner is transferred, in a desired shape, on a label forming region of a label substrate that includes a release sheet with an adhesive applied thereto, by an electrophotographic printing process. Then, the toner is heated (fused) to form a label film on the label forming region, thereby producing a label. In the method, a label can be produced on demand in a desired shape. As a label of a desired shape is formed on the label substrate, there is no need to cut the label. In addition, a user can easily obtain a label with an adhesive layer by peeling the label from the release sheet.

The method enables label formation by an electrophotographic printer (formation of a label film) and label print (printing an image such as a picture on the label film formed). Thus, in the method, a label with an adhesive layer is ejected from a label making apparatus (an electrophotographic printer) with a desired image printed thereon.

Patent Literature 2 proposes use of a UV curable resin as a binding resin for toner for forming a label. In Patent Literature 2, a highly strong label film is formed by UV irradiation of the film during or after a fixation process. Although selection of a material of the toner for forming a label from high-molecular-weight resins results in increased film strength, the material is difficult to be pulverized in production of the toner, which results in reduced productivity of the toner. In contrast, use of a low-molecular-weight resin having high ease of pulverization would result in reduced film strength. Thus, use of a UV curable resin for toner for forming a label can provide both of ease of pulverization and high film strength.

Patent Literature 3 proposes that the density of a toner for forming a label in a toner image is improved by reducing the linear speed of a conveyor belt that feeds a label substrate. The proposal can provide a fixed label-film having a desired thickness.

Patent Literature 4 proposes use of toner for forming a label, the toner including polylactic acid having an average mass molecular weight of 100,000 or more as a binding resin. The proposal can provide a highly strong label.

Patent Literature 5 proposes a method for producing a label, the method including a step of curing, with UV radiation, a region of an adhesive layer other than a region for forming a label. The proposal can prevent an excessive adhesive from remaining on a label film, when the label film is released from a release sheet. This can provide a label having high handleability.

### CITATION LIST

### Patent Literature

Patent Literature 1: Japanese Patent No. 4765810

Patent Literature 2: Unexamined Japanese Patent Application Kokai Publication No. 2010-184470

Patent Literature 3: Unexamined Japanese Patent Application Kokai Publication No. 2011-107418

Patent Literature 4: Unexamined Japanese Patent Application Kokai Publication No. 2012-108300

Patent Literature 5: Unexamined Japanese Patent Application Kokai Publication No. 2012-139982

### SUMMARY OF INVENTION

### Technical Problem

As described above, a method for producing a label needs a substrate with an adhesive applied thereto. When the adhesive applied to the substrate is exposed to the air, a substrate is difficult to move in a label making apparatus (electrophotographic printer). Thus, it is desired to coat a surface of adhesive layer with a less viscosity layer.

In Patent Literature 1, the label coat layer is a transparent layer that covers an adhesive layer and that is formed by applying, melting, and fixing thermoplastic resin powder of vinylidene chloride.

In Patent Literature 4, a coat layer is formed on the surface of an adhesive layer. The coat layer is formed by applying particles (having a D50 (volume based) of 8 μm) formed by melt-kneading a polyester resin and titanium oxide and pulverizing the kneaded product, and melting the particles at 160° C.

In Patent Literature 5, a coat layer is not provided. A region of an adhesive layer other than a region for forming a label is cured with UV radiation, and thus loses adhesion.

Preferably, a coat layer that covers an adhesive layer makes it easier to move a substrate with an adhesive applied thereto in a label making apparatus. It is also necessary that a coat layer can be readily released while conforming to the shape of a label (conformability to the label shape), when a user releases the label film from the label substrate after production of a label.

Preferably, a coat layer has both of a good ability to bind to the label film and a good ability to bind to an adhesive layer. It is desirable that when a label film applied to an object is released from the object after use, the label film, the coat layer, and the adhesive layer are clearly released all together.

A possible method for producing a coat layer includes dissolving a resin component of the coat layer in an organic solvent, applying the solution with a coater (a device for applying, with a roller, a coating solution to a long substrate that is continuously fed) and an applicator (a device for applying a coating solution to a substrate that moves downward from a gap having a predetermined width) to form a layer. However, the method requires collection of the volatilized organic solvent.

The present invention is directed to providing a label substrate that is easily carried in a label making apparatus and has high conformability to the label shape when the label is peeled from a release sheet, plus the label substrate has coat layer that has high binding capability to a label film and an adhesive layer; and a method for producing a label and a label substrate.

### Solution to Problem

To solve the above problem, the present disclosure provides a label substrate that includes a release sheet having, on at least one side, a release surface that enables release of an adhesive applied thereto;

an adhesive layer disposed on the release surface; and

a coat layer disposed on a surface opposite to the release surface of the adhesive layer,

wherein a resin forming the coat layer comprises (i) a resin that has a structure in common with a resin component of a label forming toner that is transferred and fused to a surface of the coat layer opposite to the surface of the adhesive layer thereon and/or (ii) a resin that has a structure in common with a resin component of the adhesive.

To solve the above problem, the present disclosure also provides a label having an adhesive layer, wherein the label is formed by transferring and fusing a label forming toner on the label substrate.

To solve the above problem, the present disclosure also provides a method for producing a label substrate, the method including an adhesive layer forming step of forming an adhesive layer by applying an adhesive on a release surface of a release sheet, wherein the release sheet has, on at least one side, the release surface that enables release of the adhesive applied thereto;

an emulsion preparation step of preparing an emulsion by dispersing, in water, (i) a resin that has a structure in common with a resin component of a label forming toner that is transferred and fused to make a label and/or (ii) a resin that has a structure in common with a resin component of the adhesive; and

an emulsion applying step of applying the emulsion prepared in the emulsion preparation step on the adhesive layer.

### BRIEF DESCRIPTION OF DRAWINGS

FIG. 1 is a schematic view of a label making apparatus.

FIG. 2A illustrates a first step for producing a label using a label substrate in a label making apparatus.

FIG. 2B illustrates a step following the step illustrated by FIG. 2A.

FIG. 2C illustrates a step following the step illustrated by FIG. 2B.

FIG. 2D illustrates a step following the step illustrated by FIG. 2C.

FIG. 2E illustrates a step following the step illustrated by FIG. 2D.

FIG. 2F illustrates a step following the step illustrated by FIG. 2E.

FIG. 3A illustrates a first step in dip coating.

FIG. 3B illustrates a step following the step illustrated by FIG. 3A.

FIG. 3C illustrates a step following the step illustrated by FIG. 3B.

FIG. 3D illustrates a step following the step illustrated by FIG. 3C.

### DESCRIPTION OF EMBODIMENTS

Now, terms used in the present disclosure will be described, and then embodiments of the present disclosure will be described.

### DEFINITION OF TERMS

The term label making apparatus refers to an apparatus for transferring and fusing a label forming toner in a desired shape on a substrate. More particularly, a label making apparatus is an electrophotographic printer that uses label forming toner as well as printing toner, and has the function of transferring and fusing the label forming toner on a desired region of a print medium (a label substrate as described below).

The term label forming toner refers to toner that is transferred on a label forming region of a print medium (a label substrate) to form a film label. The label forming toner is transferred and fused in the similar manner as in an electrophotographic development and fuse process. The label forming toner is simply referred to as “label toner”.

The term label substrate refers to a print medium of the label making apparatus, the label substrate includes a release sheet (separator), an adhesive layer formed on the release sheet, and a coat layer covering an adhesive layer's surface. A size of the label substrate that can be used in the label making apparatus is pre-manufactured in a plant, and then delivered to a user of the label making apparatus. The label substrate is supplied into the label making apparatus, where the toner is transferred and fused to the substrate, then the substrate is ejected from the label making apparatus. After ejection the label substrate includes a film label formed only on a label forming region and a desired image printed on the film label. In other words, the toner is not transferred to marginal region which is a region except label forming region, and the coat layer is exposed. The coat layer just under the film label formed on the label forming region act as a bind agent and enhances binding capability between the film label on the coat layer and the adhesive layer under the coat layer. After a label is produced, the label substrate is stored until it is used, and is transported if necessary.

The core of a label is the label film. The label is used by put the label on a object such as office equipment, a shelf, or a locker, with adhesion of the adhesive layer. Thus, the adhesive layer is bound on a back side of the label.

When the adhesive layer is bound on a back side of the label, the label is referred to as a label having an adhesive layer. Whether the label is put on any object or not (for example, the label is stored for use with a release sheet), the label is referred to as a label having an adhesive layer.

The term a resin that has a common structure means that the resins have a common chemical structure (for example, a common backbone). For example, polyester resins have a common structure. The acrylic resins also have a common structure.

<<Internal Structure of Label Making Apparatus>>

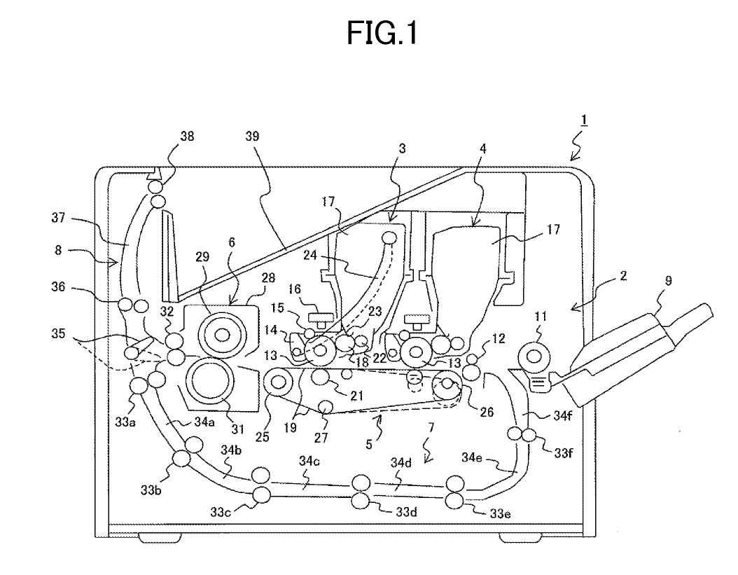

FIG. 1 is a cross-sectional view illustrating the internal structure of a label making apparatus according to an embodiment of the present disclosure. As illustrated in FIG. 1, the label making apparatus 1 includes a paper feeding unit 2, a label forming unit 3, a print unit 4, a conveyance unit 5, a fusing unit 6, a backward feeding unit 7, and a paper ejection unit 8.

The paper feeding unit 2 includes a paper supply tray 9 sloping outwardly and upwardly from a side surface of the label making apparatus 1, a paper feed roller 11 in contact with the forward edge of the paper supply tray 9, and a paired standby roller 12 disposed downstream of the paper feed roller 11. A label substrate, which is applied an adhesive on a release sheet and has coat layer on the adhesive, is set on the paper supply tray 9 The “label substrate” and the “coat layer”, which characterize the present disclosure, will be describe in detail below.

The label forming unit 3 includes a photoconductor drum 13, a cleaner 14 extending across the photoconductor drum 13, an initialization charging device 15, an optical write head 16, a powder hopper 17, an image development roller 18 rotatably disposed in a lower opening of a powder hopper 17, a conveyor belt 19, and a transfer roller 21 confronting and abutting the photoconductor drum 13 across the conveyor belt 19.

The powder hopper 17 contains label forming toner. A powder supply roller 22 is disposed so that the roller 22 is buried within the toner and slidably contacts the image development roller 18. A doctor blade 23 is slidably disposed in contact with the image development roller 18.

A collection pipe 24 is disposed between the cleaner 14 and the powder hopper 17. The collection pipe 24 includes a long feeding screw in the pipe 24 and collects, into the powder hopper 17, the powder toner that is removed from the photoconductor drum 13 and then accumulated in the cleaner 14.

The print unit 4 has the same configuration as the label forming unit 3 except that the station 4 does not include the collection pipe 24 and that the powder hopper 17 does not contain the label forming toner but contains black toner for printing an image. The hopper 17 in the print unit may contain not only black toner, but also magenta toner, cyan toner, and yellow toner to provide a color print unit.

The conveyance unit 5 includes the conveyor belt 19, a drive roller 25 and a driven roller 26 that support the belt 19, a tension roller 27 for applying a tension to the conveyor belt 19, a rotating member for bringing an upstream portion (a right portion in FIG. 1) of the conveyor belt 19 into contact with the photoconductor drum 13 in the print unit 4 (as illustrated by the solid line) or separating the upstream portion from the drum 13 (as illustrated by the dashed lines), and the like. The rotating member is constituted by, for example, a combination of known mechanical members.

The fusing unit 6 includes a thermal insulation housing 28, a heat roller 29 and a pressure roller 31 that are disposed in the thermal insulation housing 28 and that are opposed to each other, and an carry out roller 32 that is disposed downstream (to the left hand in FIG. 1) of the heat roller 29 and the pressure roller 31.

The backward feeding unit 7 includes 6 paired backward feeding roller 33 (33a-33f) that are substantially equally spaced between the carry out roller 32 in the fusing unit 6 and the paired standby roller 12 in the paper feeding unit 2 and includes backward feeding guides 34 (34a-34f) that are disposed between the respective paired backward feeding roller 33.

The paper ejection unit 8 includes a switching flap 35 that is disposed right after the carry out roller 32 in the fusing unit 6, a paired conveyance roller 36 that are disposed downstream and above the switching flap 35, an paper ejection guide 37, a paired paper ejection roller 38 that are disposed at the end of the paper ejection guide 37, and an paper ejection tray 39 that slopes upwardly from an outward and downward position from the paired paper ejection roller 38 and that is formed at the top of the body of the label making apparatus 1.

<<Process for Producing Label>>

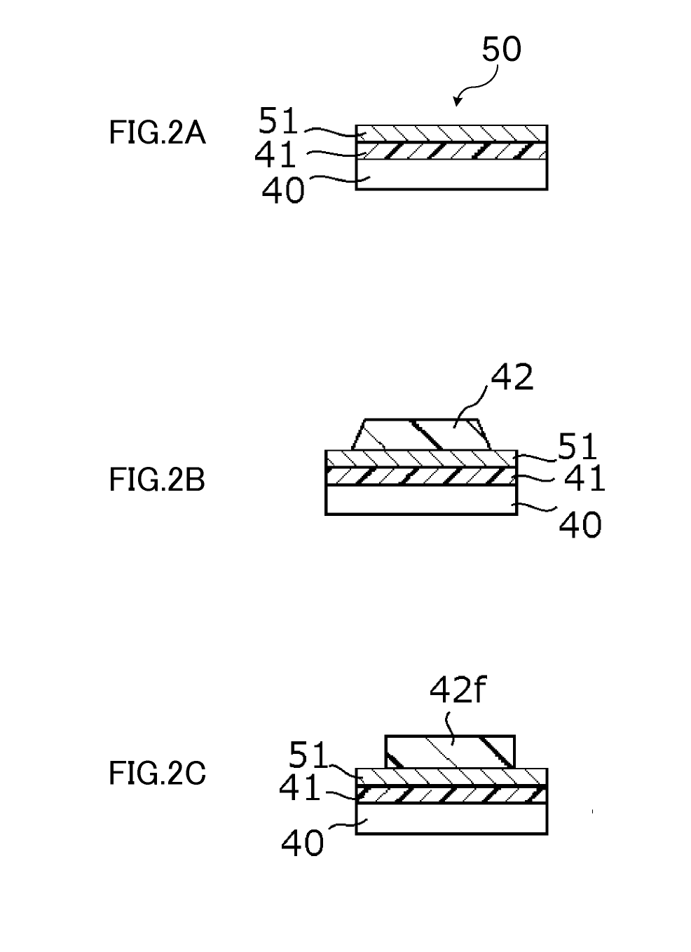

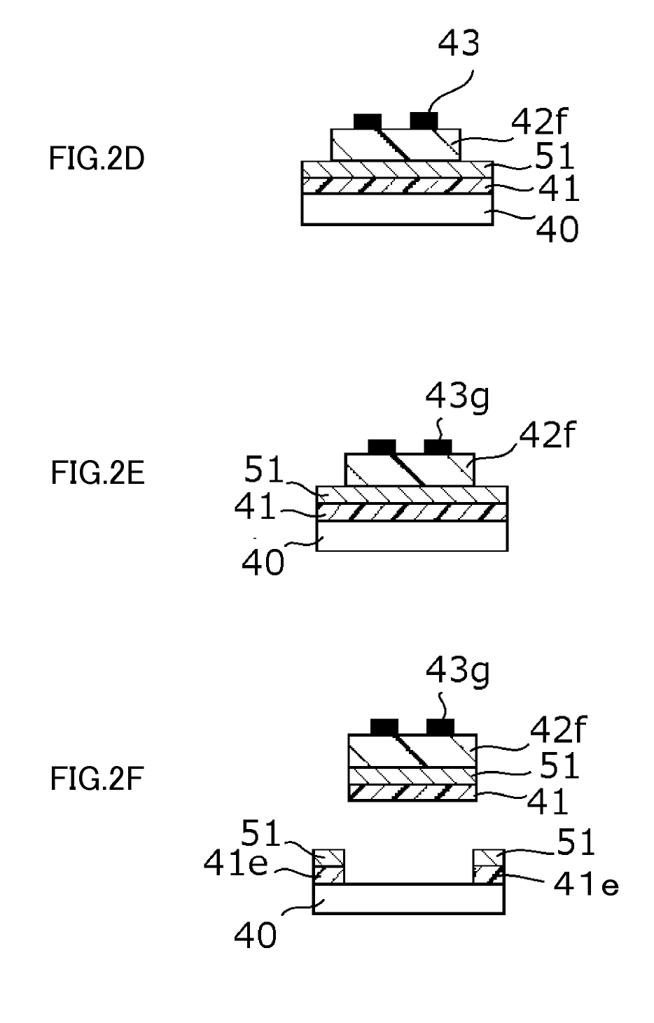

FIGS. 2A-2F schematically illustrates a process for producing a label using the label making apparatus 1 as described above. Now, the process for producing a label will be described with reference to FIGS. 2A-2F.

FIG. 2A illustrates a first step in the process for using a label substrate in the label making apparatus to produce a label, that is, illustrates a label substrate 50 (a release sheet with an adhesive applied thereto) to be set on the paper supply tray 9 of the label making apparatus 1. As illustrated in FIG. 2A, the label substrate 50 includes a release sheet 40, an adhesive layer 41 on the release sheet 40, and a coat layer 51 on the adhesive layer 41. The label substrate has a layered structure of the release sheet, the adhesive layer, and the coat layer.

The coat layer 51 is formed from a monomer or an oligomer such as a dimer, a timer, or a tetramer of a resin having a lower viscosity compared with an adhesive that constitutes the adhesive layer 41. The label substrate 50 is carried in the label making apparatus 1, and thus if the adhesive layer 41 is exposed on a surface of the label substrate 50, the adhesive layer 41 sticks to the rollers, the conveyor belt 19, and the like, which causes problems. To avoid the problems, the material of the coat layer 51 is selected from resins having a lower viscosity compared with the adhesive layer 41. A method for applying the resin will be described below.

The label substrate 50 is carried through the paper feed roller 11 into the label making apparatus 1, and then carried toward the paired standby roller 12. The paired standby roller 12 stops rotation temporarily and hit the tip of the label substrate 50 in the gap between the rollers 12. Then label substrate 50 stops moving and wait until conveyance timing.

In an initial mode, the print unit 4 is configured not to apply a bias to the image development roller 18 and the transfer roller 21 (or to apply a reverse bias). In the mode, the print unit 4 cannot print an image using black toner.

When the printing function of the print unit 4 is turned off, the conveyor belt 19 is moved into a position as illustrated by the dashed lines in FIG. 1, by rotation of a rotating member. This allows the conveyance surface of the conveyor belt 19 to be in contact only with the photoconductor drum 13 in the label forming unit 3.

In this state, the photoconductor drum 13 in the label forming unit 3 rotates clockwise. The initialization charging device 15 uniformly provide a highly negative charge on the outer surface of the photoconductor drum 13. The optical write head 16 scans a beam across the photoconductor drum 13 based on an image signal to discharge certain points.

This forms a latent electrostatic image consisting of the areas highly negatively charged in the charging step and the areas discharged in the scanning step, on the surface of the photoconductor drum 13.

The powder supply roller 22 supplies powdered label-toner to the image development roller 18 by applying the toner to the roller. The doctor blade 23 controls the amount of the toner on the surface of the image development roller 18 to keep the toner thickness constant. Then, the friction gives rise to a low negative charge on the toner, which then adheres to the surface of the image development roller 18.

The image development roller 18 carries the toner applied to the surface at a uniform thickness to a zone where the image development roller 18 meets the photoconductor drum 13, that is, the image development unit, while the roller is rotating.

To the image development roller 18, a bias of, for example, “−250 V” is applied from a power source. The discharged area on the photoconductor drum 13 that carries the latent electrostatic image has a lower charge of, for example“−70 V”, which is decreased in the scanning step.

Thus, there is a potential difference of “−180 V” between the photoconductor drum 13 and the image development roller 18 in the image development unit. In other words, the discharged area that defines the latent electrostatic image is positively charged relative to the image development roller 18.

Due to the potential difference, the negatively charged toner is driven to the relatively positively charged area of the photoconductor drum 13 that carries the latent electrostatic image. The toner forms a solid image of a desired shape on the photoconductor drum 13.

The solid image formed by the toner is moved, by rotation of the photoconductor drum 13, to the transfer zone where the drum 13 meets the transfer roller 21.

At the time when the solid image on the photoconductor drum 13 is moved, by rotation of the drum 13, to the zone where the drum 13 meets the transfer roller 21, the label substrate 50 is fed to the zone.

The transfer roller 21 applies a voltage from a bias power source to the label substrate 50 via the conveyor belt 19. Due to the voltage, the toner solid image on the photoconductor drum 13 is transferred to the label substrate 50.

Embodiments of the toner that can be used include polyester toners as described below.

FIG. 2B illustrates a step following the step illustrated by FIG. 2A, in which a solid image 42 of label toner is transferred to a surface of the adhesive layer 41 on the release sheet 40. The toner that is not transferred and remains on the photoconductor drum 13 is removed from the outer surface of the photoconductor drum 13 by the cleaner 14. Then, the removed toner is collected through the collection pipe 24 into the powder hopper 17.

The label substrate 50 with the toner solid image 42 transferred thereto is carried to the fusing unit 6, where the substrate 50 is heated by the heat roller 29 and is pressed by the pressure roller 31, thereby fusing the toner solid image 42, which is in the form of a film label, to the surface of the adhesive layer 41. The fusing process partially polymerizes a component of the adhesive layer 41 with a component of the film label 42f to form a polymer. In the process, the coat layer 51, which is formed from a monomer or an oligomer and disposed between the adhesive layer 41 and the film label 42f, is copolymerized with the components of the layer 41 and the film label 42f to form a copolymer, thereby functioning as a bind agent.

FIG. 2C illustrates a step following the step illustrated by FIG. 2B, in which the toner solid image 42 is fused to the surface of the adhesive layer 41 of the label substrate 50 to form the film label 42f.

The label substrate 50 that includes the film label 42f fused to the surface of the adhesive layer 41 is carried into the backward feeding unit 7, when a switching flap 35 is opened as illustrated by the solid line.

Then, the label substrate 50 carried into the backward feeding unit 7 is carried backwardly through the 6 paired backward feeding roller 33 (33a-33f) and the backward feeding guides 34 (34a-34f) to the paired standby roller 12.

In this timing, applying a bias to the image development roller 18 and the transfer roller 21 stops in the label forming unit 3, and thus a function for forming film label turned off.

Instead, applying bias to the image development roller 18 and the transfer roller 21 starts in the print unit 4, and then a print function using black toner turned on.

When the print function turned on, the conveyor belt 19 is moved into a position as illustrated by the solid line, by rotation of a rotating member, which allows the conveyance surface of the conveyor belt 19 to contact the photoconductor drum 13 in the print unit 4.

Then, a print data image of black toner in the print unit 4 is transferred to the surface of the film label 42f, in a similar manner to the solid image 42 developed and transferred in the label forming unit 3 as described above.

The technique for forming an image on the film label 42f is not limited to the electrophotographic printing process as described above, inkjet printing can be used.

FIG. 2D illustrates a step following the step illustrated by FIG. 2C, in which a desired black toner image 43 is transferred to the film label 42f formed on the surface of the adhesive layer 41 on the release sheet 40.

Then, the label substrate 50 with the desired black toner image 43 transferred to the film label 42f is carried to the fusing unit 6. The fusing unit 6 heats and presses the label substrate 50 to fuse the image 43 to the film label 42f.

FIG. 2E illustrates a step following the step illustrated by FIG. 2D, in which a fused image 43g, which is formed by fusing the image 43, is formed on the film label 42f. As the switching flap 35 is closed as illustrated by the dashed lines, the label substrate 50 that includes the fused image 43g is ejected through the paired conveyance roller 36, the paper ejection guide 37, and the paired paper ejection roller 38 to the paper ejection tray 39.

FIG. 2F illustrates a step following the step illustrated by FIG. 2E, in which the film label 42f is released from the release sheet 40. In this step, the film label 42f is bound to the adhesive layer 41, which is disposed under the film label 42f, via binding power of the coat layer 51. Thus, the film label 42f can be released with the adhesive layer 41 that is same shape of the film label 42f because of high conformability to the label shape. The binding power of the coat layer will be described below. The rest of the adhesive layer 41, which is not released with the film label 42f, is a marginal region 41e.

<<Order of Formation of Film Label and Printing on Label>>

In the process for producing a label as described above, the print data image 43 is formed on the film label 42f. The step of printing the image and the step of forming the film label may be reversed. In this case, the print data image 43 is formed on the surface of the coat layer 51 of the label substrate 50, and then the film label 42f is formed. In this case, the label film is preferably highly transparent.

<<Function of Coat Layer of Label Substrate>>

The coat layer of the label substrate is provided in order to facilitate conveyance of the substrate in the label making apparatus. To facilitate the conveyance in the label making apparatus, it is necessary that the coat layer be formed of a material having a low viscosity, a sufficiently high softening-point, and excellent thermal resistance.

It is also necessary that the coat layer needs to be easily cut into a shape conformal to the label shape (conformability to the label shape) when a user peels the label from the label substrate. If the coat layer can be formed as a thin layer, the coat layer can be expected to be highly conformable to the label shape, which may be beneficial to design of the substrate.

Preferably, the coat layer has high binding capability to both the label film and the adhesive layer. After the label film is put on an object, then if the user peel the label film from the object, its preferable that label film, coat layer, and the adhesive layer are peeled all together from the object.

<<Formation of Coat Layer by Application of Emulsion>>

After extensive study on formation of the coat layer, the inventor of the present disclosure conceived the idea of applying a monomer or an oligomer of a resin as an emulsion in water directly to the surface of an adhesive and conducted many experiments. Then, the inventor has succeeded in forming the coat layer on the adhesive surface of the label substrate.

When a resin solution is applied with a coater or applicator, it is necessary to use a thick solution in an organic solvent, which results in formation of a coat layer having a thickness of tens of micrometers or more (for example 20 μm). However, when an emulsion is applied by dip coating, spray coating, or the like, a thin emulsion in water can be used, which allows formation of a coat layer having a thickness of several micrometers (for example, 1-5 μm).

More particularly, a method, according to the present disclosure, for producing a label substrate for use in a label making apparatus that transfers label forming toner, in a desired shape, to the substrate and fuses the toner to the substrate includes

an adhesive layer forming step forming an adhesive layer on a release sheet,

an emulsion preparation step of preparing an emulsion by dispersing, in water, (i) a resin that has a structure in common with a resin component of the label forming toner and/or (ii) a resin that has a structure in common with a resin component of the adhesive,

an emulsion applying step of applying the emulsion prepared in the emulsion preparation step on the adhesive layer formed on the release sheet, and

a dry step of drying the emulsion applied in the emulsion applying step.

As used herein, the term emulsion refers to a dispersion solution which both dispersed material and dispersion medium are liquid. In the invention, the dispersion medium is, for example, water (ion-exchange water).

The emulsion is prepared by adding a dispersion medium (for example, water) to a dispersed material with stirring to give a desired concentration. When two or more materials are mixed at a desired ratio to provide a mixture for use as the dispersed material before the emulsion is prepared, some of the materials to be mixed are volatilized, and the portion that is not volatilized is collected. The portion is measured for mass and adjusted to provide a mixture having a mixture rate desired for the dispersed material. Then the resultant mixture was added in portions to a dispersion medium with stirring to give an emulsion having a desired concentration.

A resin that is the dispersed material uses a monomer or an oligomer. A monomer is a single molecule that is a substrate for polymerization. Polymerization is a chemical reaction in which a polymer is formed. Oligomers include dimers, trimers, tetramers, and the like.

The application step may be carried out by any suitable technique, including, but not limited to, dip coating and spray coating.

The drying step may be carried out by any suitably technique, including natural drying, forced drying using heat (heated air), and the like. In the case of natural drying, the emulsion is dried for, for example, 24 hours.

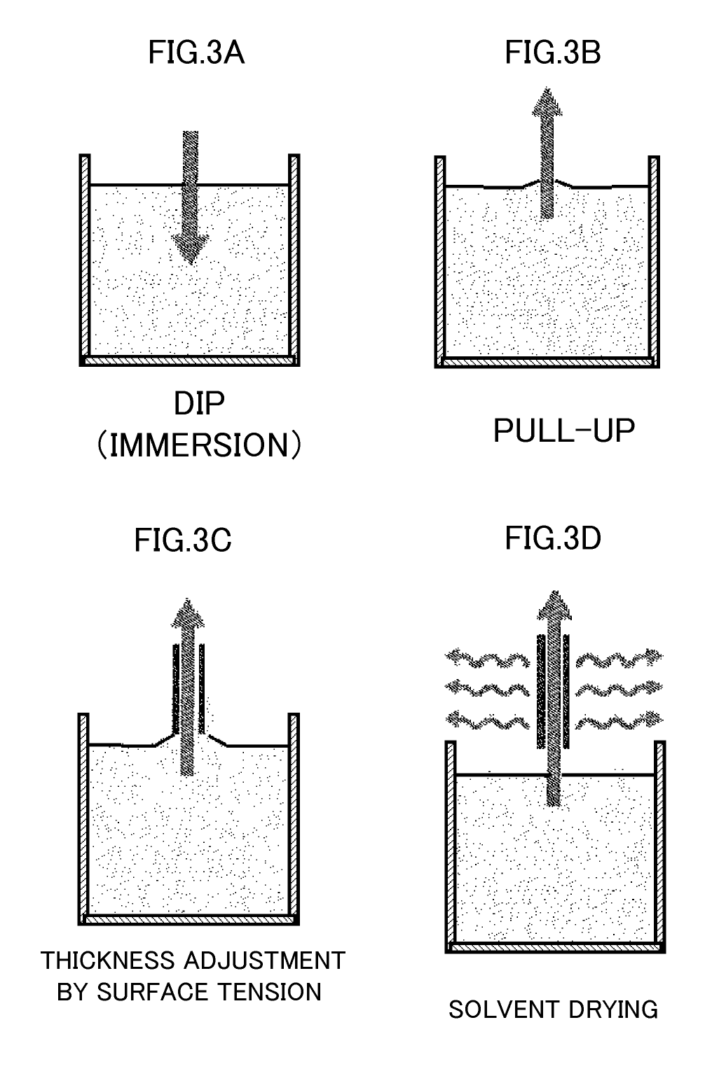

FIGS. 3A-3D illustrate the dip coating step. In FIG. 3A, a coat tank is filled with an emulsion (for example, a dispersion of a monomer or an oligomer of a resin in water). For example, two label substrates to be coated (the substrates including a release sheet with an adhesive applied thereto) are placed back-to-back and immersed (dipped) perpendicularly in the emulsion. Then, the substrates are pulled up as illustrated in FIG. 3B, while the viscosity, the surface tension, and the acceleration of gravity of the emulsion and the velocity of the substrates are adjusted. The film thickness (h) is known to be governed by the viscosity η, the pull-up velocity (v), the liquid density (d), the acceleration of gravity (g), and the like. To obtain a predetermined film thickness (the thickness of the coat layer), the density of the emulsion, which is an dispersion in a dispersion medium such as water, the pull-up velocity, the viscosity, and the like are adjusted.

In dip coating, the pull-up velocity generally needs to be reduced to obtain a small film-thickness. As illustrated in FIG. 3C, the pull-up velocity is appropriately selected to adjust the film thickness influenced by the surface tension, while the substrates are pulled up. Then, as illustrated in FIG. 3D, the dispersion medium (water in this case) is dried (by natural drying or forced drying using heat). The dip coating can provide a coat layer having a uniform thickness. In the below-described embodiment, a coat layer had a thickness of from about 1 to 5 μm.

In place of the dip coating, spray coating can be used to provide a coat layer having a thickness of from about 1 to 5 μm. When the spray coating is used, the thickness of the coat layer can be adjusted by adjusting the shape and the outlet pressure of a nozzle to be used, the density and the viscosity of the dispersion, duration of spraying, and the like.

<<Effect of Use of Application Means that Does Not Use Any Organic Solvent>>

A big difference of use of the dip coating or the spray coating to apply the emulsion from use of a coater or an applicator to apply a resin solution is in that any organic solvent is not used. Generally, organic solvents are highly volatile, and thus the solution after concentration adjustment may significantly changes in concentration (or density) over time. In contrast, the emulsion is a dispersion in water, and thus the adjusted density and the adjusted viscosity of the emulsion are relatively unchanged over time. Unlike use of an organic solvent, use of water as the dispersion medium advantageously eliminates the need of collecting the solvent (the dispersion medium).

In the dip coating, the density and the viscosity of the dispersion, the pull-up velocity, and the like are controlled to provide a coat layer having a predetermined thickness, as described above. Also in the spray coating, the concentration and the viscosity of the dispersion, the outlet pressure, and the like are controlled to provide a coat layer having a predetermined thickness. Thus, the smaller the change in the properties of the adjusted dispersion over time, the more advantageous it is to provide a coat layer having a desired thickness.

Importance of providing a coat layer having a desired thickness for conformability to the label shape and binding capability has been shown by Embodiment described below.

The label forming toner according to the present disclosure includes a resin as a main component. If necessary, a charge control agent, a wax, and a pigment are added, and the resultant is kneaded. The kneaded product is pulverized in the presence of liquid nitrogen to provide powder, which is then stirred together with a surface additive such as silica particles. Embodiment of the resin component that may be used include, but not limited to, polyester resins such as polylactic acid and polybutylene succinate, acrylic resins, ionomer resins, cellulose resins, polycarbonate resins, epoxy resins, polyethylene resins, polypropylene resins, butadiene resins, polybutylene resins, polystyrene resins, cyclic polyolefin resins, vinyl acetate resins, nitrile resins, polyacetal resins, phenol resins, polyamide resins, polyimide resins, polyether resins, polyurethane resins, furan resins, polyketone resins, polyvinylidene resins, silicone resins, polyvinyl alcohol resins, polyvinyl acetate resins, urea resins, melamine resins, polyarylsulfone resins, xylene resins, and substituted derivatives thereof, copolymers of the monomers thereof, and combinations of copolymers of the monomers thereof. Note that use of a polyester resin as a main component provides better effect.

For example, an adhesive that can be used for the adhesive layer formed on the release sheet include acrylic resins, silicon resins, and rubber resins. The release sheet is paper (or a resin sheet) that is surface-treated for releasability.

The coat layer is a resin layer for covering the adhesive layer and includes a resin that has a structure in common with a resin component of the label forming toner and/or a resin that has a structure in common with a resin component of the adhesive.

The coat layer preferably has a thickness of from 1 to 5 μm. An excessively-thick coat layer would result in reduced conformability to the label shape (the ability to allow release of the adhesive layer while remaining conformally adhered to the label, when a user releases the release sheet prior to use of the label).

The coat layer preferably includes a resin that has a structure in common with either or both of a resin included in the label forming toner and a resin included in the adhesive layer. This is to improve the binding capability and the conformability to the label shape. When a label is formed (when a label is formed on the label substrate in the label making apparatus), the coat layer serves as a bind agent by partially polymerizing or copolymerizing the resin included in the label forming toner with the resin included in the adhesive layer to form a polymer or a copolymer, respectively, to fuse the label.

The term resin that have a structure in common with another resin refers to a resin that have a common chemical structure (for example, backbone) with the another resin. For example, polyester resins have a structure in common with each other. Acrylic resins also have a structure in common with each other.

<<Binding Power of Coat Layer>>

As described above, the coat layer needs to have a good ability to bind to a label material (a material of the film label 42f) and the adhesive.

In the system for producing a label, the coat layer of the label substrate functions as a binding layer that binds the label material and the adhesive.

Thus, the ability for the coat layer to bind to the label material and to the adhesive has an effect on the strength of the label. A coat layer with poor binding power can result in that when the label put on an object is released from the object, only the label material (the film label 42f) or only the label material and the coat layer are released.

The binding power of the coat layer also provides conformability to the label shape. The ability for the coat layer to bind to the film label is provided only in a label forming region. In other words, the binding power is not provided in the regions other than the label forming region. Thus, a user can release a label from the release sheet, while part of the adhesive layer 41, which is highly conformable to the shape of the label, remains secured to the label.

When a resin component of the label forming toner is a polyester resin (for example, polybutylene succinate), and the adhesive is an acrylic adhesive (for example, SK-DYNE 1811L adhesive from Soken Chemical & Engineering Co., Ltd., and TD-75 curing agent from Soken Chemical & Engineering Co., Ltd.), use of a coat layer that includes a polyester resin and/or an acrylic resin as a main component can provide good label properties (binding power and conformability to the label shape).

The coat layer formed from a monomer or an oligomer of a polyester resin can exhibits a good ability to bind to the label substrate after the label forming toner is fused using heat.

The coat layer formed from a monomer or an oligomer of an acrylic resin as a component exhibits a high ability to bind to the acrylic adhesive. The coat layer that includes an acrylic having a high physical strength provides high strength properties such as abrasion resistance of the substrate. The coat layer that includes a resin having a high softening point can provide a high thermal resistance.

More preferably, the coat layer is formed from a mixture of a monomer (or an oligomer) of a polyester resin and a monomer (or an oligomer) of an acrylic resin. Such configuration can improve both of the ability for the coat layer to bind to the label material and the ability for the coat layer to bind to the adhesive layer. More particularly, selection of a resin similar to a resin used for the label material (a resin that has a structure or backbone in common with the resin for the label material) and a resin similar to a resin used for the adhesive and use of a mixture of the monomers of these resins for the coat layer can provide a high binding power. It is believed that the binding power is provided by at least partial polymerization between a resin of the label material and a resin component of the coat layer and between a resin component of the coat layer and a resin component of the adhesive layer during fusing of the label toner to form a copolymer.

In addition, the coat layer preferably includes a combination of a polyester resin and an acrylic resin. More particularly, the coat layer preferably includes a mixture of the two resins. Preferably, the mixture ratio based on the non-volatile mass is from 1:9 to 9:1 for the binding capability and the conformability to the label shape. Most desirably, the mixture ratio is from 3:7 to 7:3, because the binding capability is further improved. The non-volatile mass is measured using a top loading balance, after the solvent is caused to spontaneously evaporate for 2 hours. The weighed resin is further dispersed in water to provide an emulsion.

Suitable embodiment of the resin combination include a combination of a polybutylene succinate for the toner, an acrylic adhesive for the adhesive layer, and a mixture of a polyester emulsion and an acrylic resin emulsion for the coat layer. As described in embodiment below, such combination provides a high binding capability and high conformability to the label shape.

Before describing embodiment, measurement methods and devices will be described.

### <<Methods for Measuring Respective Physical Properties in Embodiment>>

Methods for measuring the respective physical properties are as follows:

Measurement of Softening Point

Device: flow tester (CFT-500D from Shimadzu Corp.)

Sample: 1 g

Temperature increase rate: 6° C./min

Loading: 20 kg

Nozzle: diameter of 1 mm and length of 1 mm

T_{1/2} method: The temperature at which half of the sample flows was considered as the softening point.
Measurement of Particle Diameter of Toner

Device: FPIA-2100 (from Sysmex Corp.)

Sample: A small amount of a sample, purified water, and a surfactant were added to a beaker and dispersed using an ultrasonic cleaner.

Measurement: The volume average particle diameter was determined
Measurement of Thickness of Adhesive Layer and Coat 1 Layer

The thickness was measured using μ-Mate micrometer from Sony Corp.
Label Peel Test (Binding Capability Evaluation; 90° Peel Method)

Device: AGS-J autograph from Shimadzu Corp. equipped with a 20N load cell was used to perform a tension test by the 90 degree peel method in accordance with JIS Z2307.

A test specimen having a dimension (sample size) of 60 mm×25 mm was peeled from an SUS plate (stainless steel plate) at a rate of 30 mm/sec.

The test was performed in accordance with JIS Z2307 except that the test specimen had a dimension of 60 mm×25 mm More particularly, the test specimen was applied to the SUS plate using a manual roller, and the SUS plate is set horizontally. The test was performed using the above AGS-J 20N autograph from Shimadzu Corp. equipped with a test fixture that includes a slider allowing the specimen to be constantly peeled vertically.

### Embodiment

### Production of Label Substrate

### Production Example 1

100 parts by mass of SK-DYNE 181L adhesive from Soken Chemical & Engineering Co., Ltd., which is an acrylic adhesive, and 0.2 parts by mass of TD-75 curing agent from Soken Chemical & Engineering Co., Ltd. were mixed and stirred at room temperature for 2 hours. The mixture was applied to a separator (release sheet) using an applicator and aged at 100° C. for 2 minutes.

Elitel KZT-8803 polyester emulsion from Unitika Ltd. was 4-fold diluted with ion-exchange water at room temperature to provide an emulsion. Then, a stainless steel vat sufficiently large to allow complete immersion of an A4-sized plate is filled with the emulsion. A substrate with the adhesive applied thereto was slowly immersed, with the adhesive surface down. Then, the substrate was gently pulled up and dried at room temperature overnight to provide a substrate 1. The substrate 1 had a size of A4 paper (a width of 210 mm and a length of 297 mm).

The adhesive had a thickness of 6 μm, and the coat layer had a thickness of from 4 to 5 μm.

Now, Examples that used a mixture of two different emulsions will be described. The mixture ratios are a mass ratio based on the non-volatile mass, that is, the solid mass.

### Production Example 2

A substrate 2 was prepared in the same manner as in Production Example 1 except that the emulsion was a 9:1 (based on the non-volatile mass) mixture of Elitel KZT-8803 polyester emulsion and Bariastar B-3000 acrylic resin emulsion from Mitsui Chemicals, Inc.

### Production Example 3

A substrate 3 was prepared in the same manner as in Production Example 1 except that the emulsion was a 7:3 (based on the non-volatile mass) mixture of Elitel KZT-8803 polyester emulsion and Bariastar B-3000 acrylic resin emulsion from Mitsui Chemicals, Inc.

### Production Example 4

A substrate 4 was prepared in the same manner as in Production Example 1 except that the emulsion was a 5:5 (based on the non-volatile mass) mixture of Elitel KZT-8803 polyester emulsion and Bariastar B-3000 acrylic resin emulsion from Mitsui Chemicals, Inc.

### Production Example 5

A substrate 5 was prepared in the same manner as in Production Example 1 except that the emulsion was a 3:7 (based on the non-volatile mass) mixture of Elitel KZT-8803 polyester emulsion and Bariastar B-3000 acrylic resin emulsion from Mitsui Chemicals, Inc.

### Production Example 6

A substrate 6 was prepared in the same manner as in Production Example 1 except that the emulsion was a 1:9 (based on the non-volatile mass) mixture of Elitel KZT-8803 polyester emulsion and Bariastar B-3000 acrylic resin emulsion from Mitsui Chemicals, Inc.

### Production Example 7

A substrate 7 was prepared in the same manner as in Production Example 1 except that the emulsion was Bariastar B-3000 acrylic resin emulsion from Mitsui Chemicals, Inc.

### Production Example 8

A label substrate 8 was prepared in the same manner as in Production Example 1 except that the emulsion was Bariastar B-3000 acrylic resin emulsion from Mitsui Chemicals, Inc. and that μ-Powder 3N calcium carbonate particles from Shiraishi Calcium Kaisha, Ltd. was added as additive particles in an amount twice the volatile mass of the emulsion.

### Production Example 9

Ecoflex FB-XF7011 polyester resin from BASF Corp. was dissolved in THF (tetrahydrofuran) to provide a 10% solution.

The resin solution was applied to a separator using an applicator to form a resin layer having a thickness of 10 μm.

The resultant resin layer was applied to the adhesive layer prepared in the same manner as in Production Example 1 to prepare a substrate 9.

### Production Example 10

After a first coat layer of an acrylic emulsion was formed on the adhesive layer, a second coat layer of a polyester emulsion is formed to provide a layered structure. A substrate 10 was prepared in the same manner as in Production Example 1 except for the above conditions.

The polyester emulsion and the acrylic emulsion were prepared in the same manner as in Production Examples 1-7 and Production Example 10 except that the polyester emulsion was used without any treatment, and that the acrylic emulsion was 4-fold diluted with ion-exchange water.

### Production Example 11

A substrate 11 was prepared in the same manner as in Production Example 1 except that the polyester emulsion was used without any treatment and that the acrylic emulsion was 2-fold diluted with ion-exchange water.

### Production Example 12

A substrate 12 was prepared in the same manner as in Production Example 1 except that the polyester emulsion was used without any treatment and that the acrylic emulsion was 1.5-fold diluted with ion-exchange water.

### Production Example 13

A substrate 13 was prepared in the same manner as in Production Example 1 except that both of the polyester emulsion and the acrylic emulsion were used without any treatment.

<<Synthesis of Polybutylene Succinate: Production for Producing Toner for Forming Label>>

### Synthesis Example 1

5 parts by mass of an 88% aqueous lactic acid solution in which 0.4 parts by mass of malic acid and 1 part by mass of germanium dioxide were dissolved was added to 100 parts by mass of succinic acid and 89 parts by mass of 1,4-butanediol. After establishing a nitrogen atmosphere in the reaction system, the system was allowed to react at 220° C. for an hour, and the pressure is reduced to 70 pa over a period of 1.5 hours, while heating to 230° C. The polymerization reaction was allowed to continue for 2 hours to provide polybutylene succinate.

<<Production of Toner for Forming Label>>

Toner Production Example 1

96.5 parts by mass of the polybutylene succinate prepared in Synthesis Example 1, 1 part by mass of LR-147 from Japan Carlit Co., Ltd. as a charge control agent, and 2.5 parts by mass of carnauba wax (from S. Kato & Co.) were mixed and kneaded using a two screw kneader. The kneaded product was pulverized in the presence of liquid nitrogen using Linrex Mill from Hosokawa Micron Corp. to provide powder having a D50 (volume-based) of 37 μm.

Then, 100 parts by mass of the resultant particles, 0.2 parts by mass of RY200 hydrophobic-treated silica particles from Nippon Aerosil Co., Ltd., and 0.7 parts by mass of NY50 hydrophobic-treated silica particles from Nippon Aerosil Co., Ltd. were mixed using a Henschel mixer to externally add the silica particles, thereby providing a toner 1.

D50 (volume-based): 37 μm, Softening point: 125° C.

<<Production of Label>>

### Embodiment 1

The toner 1, which is a label material, was transferred to an A4 label-substrate 1 (Production Example 1) by the electrophotographic printing process, and the label substrate 1 with the toner fused thereto was passed through a heat roll at 180° C. to provide a film label having a thickness of 80 μm on the label substrate 1 (Production Example 1).

Then, an image was developed and fused to the film label using N5300 printer from Casio Computer Co., Ltd.

### Embodiments 2-7, Embodiments 8-10, and Comparative Example 3

The label substrates 2-7 (Production Examples 2-7) and the label substrates 10-13(Production Examples 10-13) were used to produce a label in the same manner as in Embodiment 1.

### Comparative Embodiments 1-2

The label substrates 8 and 9 (Production Examples 8 and 9) were used to produce a label in the same manner as in Embodiment 1.

<<Results of Evaluation and Discussion of Results>>

The ability for the coat layer to bind to the label and the ability for the coat layer to bind to the adhesive were evaluated by the remained amount of the label and the adhesive on the SUS plate after the label was peeled, respectively.

The conformability to the label shape was evaluated by the degree of conformance to the shape of the label (Released-conformability to label) when the label was released from the substrate.

Good properties were exhibited by the labels that were produced using the substrates including a coat layer that had a thickness of 20 μm or less and preferably 5 μm or less and that was formed mainly from an emulsion including a monomer of a polyester and/or an acrylic resin.

However, in Embodiment 1, which included the coat layer produced using only a polyester, a small amount of the adhesive remained on the label SUS plate when the label is released from the SUS plate.

This result indicates that the coat layer was slightly inferior in the ability to bind to the adhesive.

In Embodiments 6 and 7, which included the coat layer having a large content of an acrylic resin, the adhesive and the coat layer remained on the SUS plate.

This result indicates that the coat layer was inferior in the ability to bind to the label.

In Comparative Example 1, in which calcium carbonate as a filler was added to the coat layer, the coat layer was split, and thus the label was separated from the adhesive layer, when the label was released from the SUS plate.

In Comparative Example 2, in which the coat layer was prepared from a polyester resin solution by application of the solution using an applicator, the coat layer clearly exhibited bad Released-conformability to label.

In Comparative Example 3, which used an acrylic emulsion without any treatment, the coat layer exhibited bad Released-conformability to label.

TABLE 1

| | | Ratio of | Thickness | Binding capability | Binding capability | Released- |
|---|---|---|---|---|---|---|
| | | polyester | of coat | between label | between | conform- |
| | | to acrylic | layer | and coat | adhesive and | ability |
| | Substrate | resin | (μm) | layer | coat layer | to label |
| Embodiment | 1 | 10:0 | 5 | Good | Good/Acceptable | Acceptable |
| 1 | | | | | | |
| Embodiment | 2 | 9:1 | 4 | Good | Good | Acceptable |
| 2 | | | | | | |
| Embodiment | 3 | 7:3 | 4 | Good | Good | Good |
| 3 | | | | | | |
| Embodiment | 4 | 5:5 | 4 | Good | Good | Good |
| 4 | | | | | | |
| Embodiment | 5 | 3:7 | 4 | Good | Good | Good |
| 5 | | | | | | |
| Embodiment | 6 | 1:9 | 4 | Good/Acceptable | Good | Good |
| 6 | | | | | | |
| Embodiment | 7 | 0:10 | 4 | Acceptable | Good | Good |
| 7 | | | | | | |
| Embodiment | 10 | 10:0/ | 9 | Good | Good | Acceptable |
| 8 | | 0:10 | | | | |
| | | (Layered | | | | |
| | | Structure) | | | | |
| Embodiment | 11 | 3:7 | 11 | Good | Good | Acceptable |
| 9 | | | | | | |
| Embodiment | 12 | 3:7 | 19 | Good | Good | Acceptable |
| 10 | | | | | | |
| Comparative | 13 | 3:7 | 25 | Good | Good | Bad |
| Example 3 | | | | | | |
| Comparative | 8 | 10:0 | 3 | The coat was | The coat was | Good |
| Example 1 | | | | split. | split. | |
| Comparative | 9 | 10:0 | 10 | Good | Good/Acceptable | Bad |
| Example 2 | | | | | | |

Although some of the embodiments of the present disclosure have been described, the scope of the present disclosure is defined only by the claims and equivalents thereof.

The present application claims priority to Japanese Patent Application No. 2013-195154 filed on Sep. 20, 2013, which is incorporated herein in its entirety.

### REFERENCE SIGNS LIST

1 Label making apparatus
2 Paper feeding unit
3, 3a, 3b Label forming unit
4 Print unit
5 Conveyance unit
6 Fusing unit
7 Backward feeding unit
8 Paper ejection unit
9 Paper supply tray
11 Paper feed roller
12 Paired standby roller
13 Photoconductor drum
14 Cleaner
15 Initialization charging device
16 Optical write head
17 Powder hopper
18 Image development roller
19 Conveyor belt
21 Transfer roller
22 Powder supply roller
23 Doctor blade
24 Collection pipe
25 Drive roller
26 Driven roller
27 Tension roller
28 Thermal insulation housing
29 Heat roller
31 Pressure roller
32 Carry out roller
33 (33a-33f) Paired backward feeding roller
34 (34a-34f) Backward feeding guide
35 Switching flap
36 Paired conveyance roller
37 Paper ejection guide
38 Paired paper ejection roller
39 Paper ejection tray
40 Release sheet
41 Adhesive layer
41e Marginal region
42 Solid image of label toner
42f Film label
43 Print data image
43g Fused image
50 Label substrate
51 Coat layer

1. A label substrate, comprising:
a release sheet having, on at least one side, a release surface that enables release of an adhesive applied thereto;
an adhesive layer disposed on the release surface; and
a coat layer disposed on a surface opposite to the release surface of the adhesive layer,
wherein a resin forming the coat layer comprises (i) a resin that has a structure in common with a resin component of a label forming toner that is transferred and fused to a surface of the coat layer opposite to the surface of the adhesive layer thereon and (ii) a resin that has a structure in common with a resin component of the adhesive.

2. The label substrate according to claim 1, wherein the coat layer has a thickness of from 1 to 20 μm.

3. The label substrate according to claim 2, wherein the adhesive layer comprises an acrylic resin as the resin component, and
wherein the resin forming the coat layer comprises a polyester resin as the resin component of the label forming toner and/or an acrylic resin.

4. The label substrate according to claim 3, wherein the resin forming the coat layer comprises a mixture of a resin that has a structure in common with the resin component of the label forming toner and a resin that has a structure in common with the resin component of the adhesive at a ratio of 9:1 to 1:9 based on the non-volatile mass.

5. The label substrate according to claim 1, wherein the adhesive layer comprises an acrylic resin as the resin component, and
wherein the resin forming the coat layer comprises a polyester resin as the resin component of the label forming toner and/or an acrylic resin.

6. The label substrate according to claim 1, wherein the resin forming the coat layer comprises a mixture of a resin that has a structure in common with the resin component of the label forming toner and a resin that has a structure in common with the resin component of the adhesive at a ratio of 9:1 to 1:9 based on the non-volatile mass.

7. A label having an adhesive layer, wherein the label is formed by transferring and fusing a label forming toner on the label substrate according to claim 1.

8. A method for producing a label substrate, the method comprising:
an adhesive layer forming step of forming an adhesive layer by applying an adhesive on a release surface of a release sheet, wherein the release sheet has, on at least one side, the release surface that enables release of the adhesive applied thereto;
an emulsion preparation step of preparing an emulsion by dispersing, in water, (i) a resin that has a structure in common with a resin component of a label forming toner that is transferred and fused to make a label and (ii) a resin that has a structure in common with a resin component of the adhesive; and
an emulsion applying step of applying the emulsion prepared in the emulsion preparation step on the adhesive layer.

9. The method for producing the label substrate according to claim 8, wherein the emulsion applying step uses dip coating or spray coating.
